(19) United States
(12) Patent Application Publication
(10) Pub. No.: US 2024/0204370 A1
(43) Pub. Date: Jun. 20, 2024

(54) Battery Cell Including Electrode Tab Having Breakage Prevention Function and Battery Module Including the Same

(71) Applicant: LG Energy Solution, Ltd., Seoul (KR)

(72) Inventors: Su Hyun Yun, Daejeon (KR); Bum Young Jung, Daejeon (KR); Hyo Sun An, Daejeon (KR)

(73) Assignee: LG Energy Solution, Ltd., Seoul (KR)

(21) Appl. No.: 18/287,548

(22) PCT Filed: Mar. 8, 2023
(86) PCT No.: PCT/KR2023/003151

§ 371 Date: Oct. 19, 2023

(30) Foreign Application Priority Data
Apr. 15, 2022 (KR) 10-2022-0047082

(51) Int. Cl. H01M 50/533; H01M 50/105; H01M 50/178; H01M 50/188

(52) U.S. Cl. CPC H01M 50/533; H01M 50/105; H01M 50/178; H01M 50/188

(57) ABSTRACT

The present invention relates to a battery cell including an electrode tab having a breakage prevention function and a battery module including the same, and more particularly a battery cell including a case configured to have a laminate sheet structure, an electrode assembly received in the case, an electrode tab located at a side surface of the electrode assembly, an electrode lead having one side connected to the electrode tab and the other side projecting out of the case, and an insulative film provided at each of an upper surface and a lower surface of the electrode lead, wherein the electrode tab is provided with a buffer portion, the length of the buffer portion being adjustable, and a battery module including the same.

### TECHNICAL FIELD

This application claims the benefit of priority to Korean Patent Application No. 2022-0047082 filed on Apr. 15, 2022, the disclosure of which is incorporated herein by reference in its entirety.

The present invention relates to a battery cell including an electrode tab having a breakage prevention function and a battery module including the same, and more particularly to a battery cell including an electrode tab having a breakage prevention function capable of preventing breakage of the electrode tab due to movement of an electrode assembly or external impact applied to the electrode assembly as the result of the electrode tab having the breakage prevention function and a battery module including the same.

### BACKGROUND ART

With recent development of alternative energies due to air pollution and energy depletion caused as the result of use of fossil fuels, demand for secondary batteries capable of storing electrical energy that is produced has increased. The secondary batteries, which are capable of being charged and discharged, are intimately used in daily life. For example, the secondary batteries are used in mobile devices, electric vehicles, and hybrid electric vehicles.

Required capacities of secondary batteries used as energy sources of various kinds of electronic devices inevitably used in modern society have been increased due to an increase in usage of mobile devices, increasing complexity of the mobile devices, and development of electric vehicles. In order to satisfy demand of users, a plurality of battery cells is disposed in a small-sized device, whereas a battery module including a plurality of battery cells electrically connected to each other or a battery pack including a plurality of battery modules is used in a vehicle.

Meanwhile, battery cells are used in electric vehicles or smartphones. As the result of movement of a battery cell caused by external impact or swelling of the battery cell occurring during charging and discharging, tension is applied between an electrode tab and an electrode lead, whereby the electrode tab and the electrode lead may be broken.

FIG. 1 is a sectional view of a conventional battery cell. As shown in FIG. 1, the conventional battery cell includes an electrode assembly 10, an electrode tab 20 extending from one side of the electrode assembly 10, a buffer portion 30 formed at the electrode tab 20, and an electrode lead 40 having one side connected to the electrode tab 20 and the other side projecting out of a case.

The conventional battery cell is configured such that, when tension is applied to the electrode tab 20 due to swelling, etc., the bent buffer portion 30 provided at the electrode tab 30 is relaxed to reduce the tension, whereby breakage of the electrode tab 20 is prevented.

Since the buffer portion 30 of the electrode tab 20 is bent, however, the volume of the battery cell is increased, whereby energy density of the battery cell is reduced.

Furthermore, since the overall length of the electrode tab 20 is increased, resistance is increased and manufacturing cost is increased.

### PRIOR ART DOCUMENT

(Patent Document 1) Korean Patent Application Publication No. 2019-0067312

### DISCLOSURE

### Technical Problem

The present invention has been made in view of the above problems, and it is an object of the present invention to provide a battery cell configured such that breakage of an electrode tab and an electrode lead is prevented even when an electrode assembly moves or swells due to external vibration or impact and a battery module including the same.

It is another object of the present invention to provide a battery cell configured such that breakage of an electrode tab and an electrode lead is prevented without increase in volume of the battery cell and without increase in material cost and a battery module including the same.

### Technical Solution

In order to accomplish the above objects, a battery cell including an electrode tab having a breakage prevention function according to the present invention includes a case (100) configured to have a laminate sheet structure, an electrode assembly (200) received in the case (100), an electrode tab (300) located at a side surface of the electrode assembly (200), an electrode lead (400) having one side connected to the electrode tab (300) and the other side projecting out of the case (100), and an insulative film (500) provided at each of an upper surface and a lower surface of the electrode lead (400), wherein the electrode tab (300) is provided with a buffer portion (310), the length of the buffer portion being adjustable.

Also, in the battery cell according to the present invention, the buffer portion (310) may be located between a connection portion (W) with the electrode tab (300) and the electrode assembly (200).

Also, in the battery cell according to the present invention, the buffer portion (310) may be configured such that a plurality of first zigzag break lines (311) is formed in a longitudinal direction of the electrode tab (300).

Also, in the battery cell according to the present invention, the buffer portion (310) may be configured such that a plurality of first wavy break lines (311) is formed in the longitudinal direction of the electrode tab (300).

Also, in the battery cell according to the present invention, the buffer portion (310) may be configured such that a plurality of zigzag incision lines (313) is formed in the longitudinal direction of the electrode tab (300).

Also, in the battery cell according to the present invention, the buffer portion (310) may be configured such that a plurality of wavy incision lines (313) is formed in the longitudinal direction of the electrode tab (300).

Also, in the battery cell according to the present invention, a second break line (312) may be formed at each of opposite edges of the buffer portion (310) in a lateral direction thereof.

Also, in the battery cell according to the present invention, the buffer portion (310) may be configured such that a part of each of the opposite edges of the buffer portion in the lateral direction thereof is incised in a zigzag shape and such that a plurality of first zigzag break lines (311) is formed in the longitudinal direction of the electrode tab (300).

Also, in the battery cell according to the present invention, the buffer portion (310) may be configured such that a part of each of the opposite edges of the buffer portion in the lateral direction thereof is incised in a wavy shape and such that a plurality of first wavy break lines (311) is formed in the longitudinal direction of the electrode tab (300).

Also, in the battery cell according to the present invention, the buffer portion (310) may be configured such that a part of each of the opposite edges of the buffer portion in the lateral direction thereof is incised in a zigzag shape and such that a plurality of zigzag incision lines (313) is formed in the longitudinal direction of the electrode tab (300).

Also, in the battery cell according to the present invention, the buffer portion (310) may be configured such that a part of each of the opposite edges of the buffer portion in the lateral direction thereof is incised in a wavy shape and such that a plurality of wavy incision lines (313) is formed in the longitudinal direction of the electrode tab (300).

Also, in the battery cell according to the present invention, the buffer portion (310) may be located so as not to overlap the insulative film (500) on a vertical line.

In addition, the present invention provides a battery module including the battery cell having the above features.

In addition, the present invention provides a battery pack including the battery module.

### Advantageous Effects

As is apparent from the above description, a battery cell according to the present invention has an advantage in that a part of an electrode tab is provided with a buffer portion constituted by a break line or an incision line, whereby it is possible to prevent breakage of the electrode tab and an electrode lead even when an electrode assembly moves or swells.

In addition, the battery cell according to the present invention has a merit in that, since the buffer portion is constituted by the break line or the incision line, the volume of the battery cell is not increased, whereby it is possible to prevent decrease in energy density.

Furthermore, the battery cell according to the present invention has an advantage in that, since the buffer portion is constituted by the break line or the incision line, the length of the electrode tab is not increased, whereby it is possible to inhibit increase in material cost.

### DESCRIPTION OF DRAWINGS

FIG. 1 is a sectional view of a conventional battery cell.

FIG. 2 is an exploded perspective view of a battery cell according to a first preferred embodiment of the present invention.

FIG. 3 is an enlarged perspective view of an electrode tab according to a first preferred embodiment of the present invention.

FIG. 4 is an enlarged perspective view of an electrode tab according to a second preferred embodiment of the present invention.

FIG. 5 is an enlarged perspective view of an electrode tab according to a third preferred embodiment of the present invention.

FIG. 6 is an enlarged perspective view of an electrode tab according to a fourth preferred embodiment of the present invention.

FIG. 7 is an enlarged perspective view of an electrode tab according to a fifth preferred embodiment of the present invention.

FIG. 8 is an enlarged perspective view of an electrode tab according to a sixth preferred embodiment of the present invention.

FIG. 9 is an enlarged perspective view of an electrode tab according to a seventh preferred embodiment of the present invention.

FIG. 10 is an enlarged perspective view of an electrode tab according to an eighth preferred embodiment of the present invention.

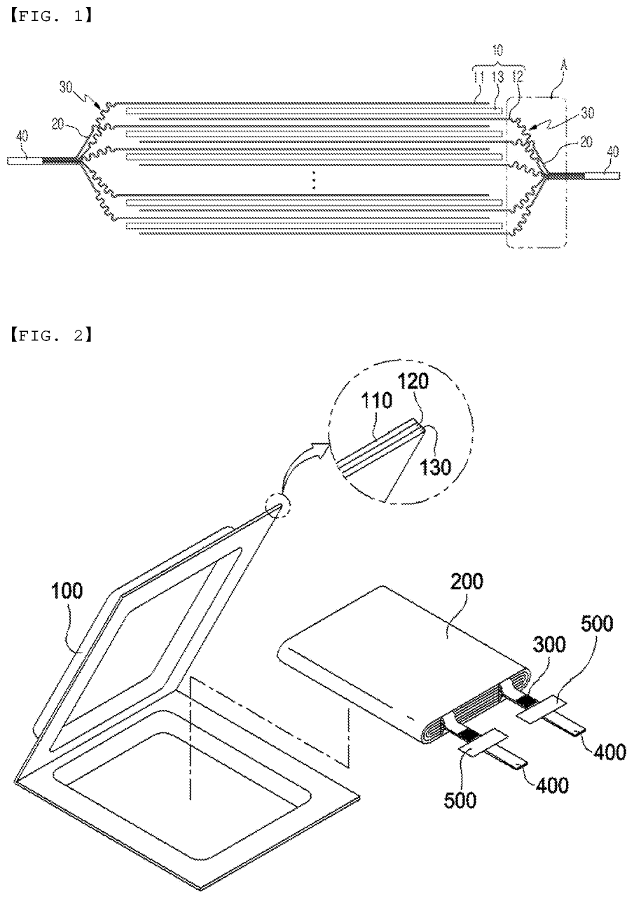

### BEST MODE

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, a battery cell including an electrode tab having a breakage prevention function according to the present invention and a battery module including the same will be described with reference to the accompanying drawings.

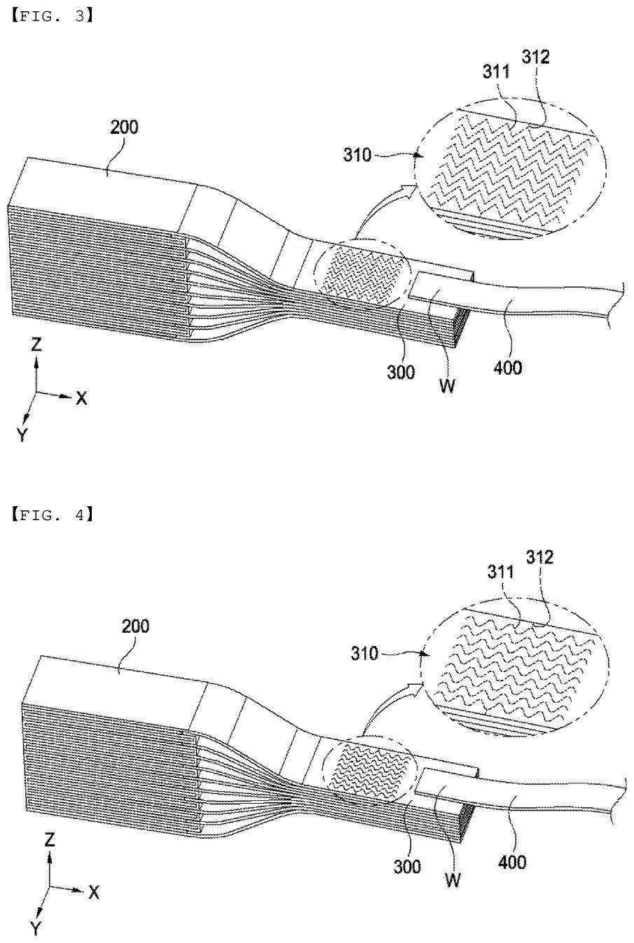

FIG. 2 is an exploded perspective view of a battery cell according to a first preferred embodiment of the present invention, and FIG. 3 is an enlarged perspective view of an electrode tab according to a first preferred embodiment of the present invention.

As shown in FIGS. 2 and 3, the battery cell according to the present invention includes a cell case 100, an electrode assembly 200, an electrode tab 300, an electrode lead 400, and an insulative film 500.

First, the case 100 may be constituted by an upper case and a lower case, and have a pocket type receiving portion configured to receive the electrode assembly 200.

In the case 100, the receiving portion is formed using a laminate sheet constituted by an outer resin layer 110, a metal layer 120, and an inner resin layer 130.

The outer resin layer 110 is located at an outer side of the case 100, and the outer resin layer 110 may be made of a heat-resistant polymer that exhibits excellent tensile strength, resistance to moisture permeation, and resistance to air transmission such that the outer resin layer exhibits high heat resistance and chemical resistance while protecting the electrode assembly 200. As an example, the outer resin layer may be made of nylon or polyethylene terephthalate; however, the present invention is not limited thereto.

The metal layer 120, which abuts the outer resin layer 110, corresponds to a barrier layer configured to prevent moisture or various kinds of gas from permeating into the battery from the outside. An aluminum thin film, which is lightweight and easily shapeable, may be used as a preferred material for the metal layer.

The inner resin layer 130 is disposed in direct contact with the electrode assembly 200, and therefore the inner resin layer must exhibit high insulation properties and high resistance to an electrolytic solution. In addition, the inner resin layer must exhibit high sealability in order to hermetically isolate the case from the outside, i.e. a thermally-bonded sealed portion between inner layers must exhibit excellent thermal bonding strength.

The inner resin layer 130 may be made of a material selected from among a polyolefin-based resin, such as polypropylene, polyethylene, polyethylene acrylic acid, or polybutylene, a polyurethane resin, and a polyimide resin, which exhibit excellent chemical resistance and high sealability; however, the present invention is not limited thereto, and polypropylene, which exhibits excellent mechanical properties, such as tensile strength, rigidity, surface hardness, and impact resistance, and excellent chemical resistance, is the most preferably used.

The electrode assembly 200, which is received in the case 100, may be a jelly-roll type electrode assembly, which is configured to have a structure in which a long sheet type negative electrode and a long sheet type positive electrode are wound in the state in which a separator is interposed therebetween, a stacked type electrode assembly including unit cells, each of which is configured to have a structure in which a rectangular positive electrode and a rectangular negative electrode are stacked in the state in which a separator is interposed therebetween, a stacked and folded type electrode assembly, which is configured to have a structure in which unit cells are wound using a long separation film, or a laminated and stacked type electrode assembly, which is configured to have a structure in which unit cells are stacked in the state in which a separator is interposed therebetween and are then attached to each other; however, the present invention is not limited thereto.

Specifically, the negative electrode is manufactured by applying a slurry mixture of a negative electrode active material and a binder to a negative electrode current collector.

As the negative electrode active material, for example, there may be used carbon, such as a non-graphitizing carbon or a graphite-based carbon; a metal composite oxide, such as LiₓFe₂O₃ (0≤x≤1), LiₓWO₂ (0≤x≤1), SnₓMe₁₋ₓMe′_{y}O_{z} (Me: Mn, Fe, Pb, Ge; Me′: Al, B, P, Si, Group 1, 2, and 3 elements of the periodic table, halogen; 0<x≤1; 1≤y≤3; 1≤z≤8); lithium metal; a lithium alloy; a silicon-based alloy; a tin-based alloy; a metal oxide, such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, or Bi₂O₅; a conductive polymer, such as polyacetylene; a Li—Co—Ni-based material; or a Si-based material, such as Si, SiO, SiO₂, or a mixture thereof; however, the present invention is not limited thereto.

The positive electrode is manufactured by applying a slurry mixture of a positive electrode active material and a binder to a positive electrode current collector.

The positive electrode active material may be constituted, for example, by a layered compound, such as a lithium cobalt oxide (LiCoO₂) or a lithium nickel oxide (LiNiO₂), or a compound substituted with one or more transition metals; a lithium manganese oxide represented by the chemical formula Li₁₊ₓMn₂₋ₓO₄ (where x=0 to 0.33) or a lithium manganese oxide, such as LiMnO₃, LiMn₂O₃, or LiMnO₂; a lithium copper oxide (Li₂CuO₂); a vanadium oxide, such as LiV₃O₈, LiFe₃O₄, V₂O₅, or Cu₂V₂O₇; a Ni-sited lithium nickel oxide represented by the chemical formula LiNi₁₋ₓMₓO₂ (where M=Co, Mn, Al, Cu, Fe, Mg, B, or Ga, and x=0.01 to 0.3); a lithium manganese composite oxide represented by the chemical formula LiMn₂₋ₓMₓO₂ (where M=Co, Ni, Fe, Cr, Zn, or Ta, and x=0.01 to 0.1) or the chemical formula Li₂Mn₃MO₈ (where M=Fe, Co, Ni, Cu, or Zn); LiMn₂O₄ in which a portion of Li in the chemical formula is replaced by alkaline earth metal ions; a disulfide compound; or Fe₂(MoO₄)₃; however, the present invention is not limited thereto.

Meanwhile, each of the negative electrode current collector and the positive electrode current collector is constituted by a portion to which the slurry including the active material is applied and an uncoated portion to which no slurry is applied. The uncoated portion is cut or a separate conductive member is connected to the uncoated portion by ultrasonic welding to form the electrode tab 300.

The electrode lead 400 is connected to the electrode tab 300 by spot welding, and the insulative film 500 is located around the electrode lead 400.

In order to minimize tension transmitted to the electrode tab 300 even when the electrode assembly moves or swells due to external impact applied thereto, the electrode tab 300 is provided with a buffer portion 310, the length of which is adjustable.

The buffer portion 310 is located between a connection portion W with the electrode tab 300 and the electrode assembly 200. It is preferable for the buffer portion not to overlap the insulative film 500 on a vertical line, i.e. it is preferable for the insulative film 500 not to be located above or under the buffer portion 310. The reason for this is that, if the buffer portion 310 and the insulative film 500 are disposed so as to overlap each other, the buffer portion 310 is not appropriately stretched even through tension is applied to the electrode tab 300 due to a swelling phenomenon, whereby it is not possible to sufficiently achieve a breakage inhibition effect.

The buffer portion 310 will be described in more detail. The buffer portion 310 is configured such that a part of the buffer portion is broken or relaxed when tension is applied to the electrode tab 300, thereby reducing the tension. A plurality of first zigzag break lines 311 may be formed.

Each of the first zigzag break lines 311 is configured to have a dotted pattern in which a part of the first zigzag break line is incised in a longitudinal direction of the electrode tab 300 (X-axis direction), i.e. a part of the first zigzag break line is cut at predetermined intervals. When tension is applied to the electrode tab 300 due to movement or swelling of the electrode assembly 200, an uncut part of the first zigzag break line 311 is broken, whereby the buffer portion 310 is relaxed, and therefore complete breakage of the electrode tab 300 is prevented.

In addition, it is preferable for the buffer portion 310 to further have a second break line 312 provided at each of opposite edges of the buffer portion 310 in a lateral direction thereof (Y-axis direction).

The second break line 312 may be configured to have a dotted pattern in which a part of the second break line is incised, in the same manner as the first break line 311. It is preferable for the second break line to be provided at the first break line 311 located at each of the outermost ones of the plurality of first zigzag break lines 311, and it is more preferable for the second break line to be provided at a part that is maximally adjacent to each of opposite edges of the electrode tab 300.

At ordinary times, the second break line 312 protects the electrode tab 300 such that the electrode tab is not broken. When tension is applied to the electrode tab 300, opposite edge parts of the buffer portion 310 are broken such that the first break lines 311 can be easily stretched.

The insulative film 500 is located in a sealed portion at which the lower case and the upper case are thermally bonded, more specifically above and under the connection portion W between the electrode tab 300 and the electrode lead 400, to prevent short circuit.

Here, it is preferable for the insulative film 500 to be made of a nonconductive material that hardly transmits electricity. In general, an insulative tape that is easily attached to the electrode lead 400 and has a relatively small thickness is mainly used; however, the present invention is not limited thereto.

Specifically, the insulative film 500 may be made of at least one material selected from the group consisting of polyimide (PI), polypropylene (PP), polyethylene (PE), polyethylene terephthalate (PET), polyvinyl chloride (PVC), high density polyethylene (HDPE), and an epoxy resin.

FIG. 4 is an enlarged perspective view of an electrode tab according to a second preferred embodiment of the present invention. Referring to FIG. 4, the battery cell according to the second embodiment of the present invention is identical to the battery cell according to the first embodiment described with reference to FIGS. 2 and 3 except for the shape of a buffer portion 310, and therefore a description of the same construction will be omitted.

In the battery cell according to the second preferred embodiment of the present invention, each first break line 311 of the buffer portion 310 has a wavy shape.

In addition, it is preferable for a second break line 312 to be provided at the first break line 311 located at each of the outermost ones of the plurality of first wavy break lines 311, and it is more preferable for the second break line to be provided so as to be connected to each of opposite edges of the electrode tab 300 at a part that is maximally adjacent to each of the opposite edges of the electrode tab 300.

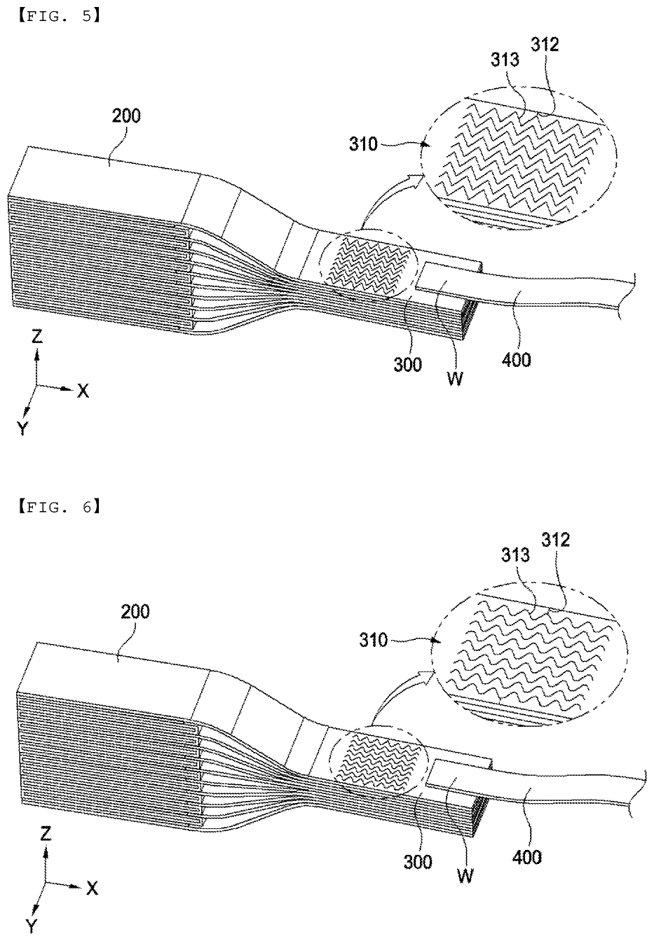

FIG. 5 is an enlarged perspective view of an electrode tab according to a third preferred embodiment of the present invention. Referring to FIG. 5, the battery cell according to the third preferred embodiment of the present invention is identical to the battery cell according to the first embodiment described with reference to FIGS. 2 and 3 except for the shape of a buffer portion 310, and therefore a description of the same construction will be omitted.

In the battery cell according to the third preferred embodiment of the present invention, the buffer portion 310 is provided with a plurality of zigzag incision lines 313 that is completely cut. In addition, a second break line 312 is provided at the incision line 313 located at each of the outermost ones of the plurality of incision lines 313.

Consequently, the battery cell according to the third embodiment has an advantage in that, when tension is applied to the electrode tab 300, the second break line 312 is broken, whereby the buffer portion is more rapidly relaxed.

FIG. 6 is an enlarged perspective view of an electrode tab according to a fourth preferred embodiment of the present invention. Referring to FIG. 6, the battery cell according to the fourth preferred embodiment of the present invention is identical to the battery cell according to the first embodiment described with reference to FIGS. 2 and 3 except for the shape of a buffer portion 310, and therefore a description of the same construction will be omitted.

In the battery cell according to the third preferred embodiment of the present invention, the buffer portion 310 is provided with a plurality of wavy incision lines 313 that is completely cut. In addition, a second break line 312 is provided at the incision line 313 located at each of the outermost ones of the plurality of incision lines 313.

Consequently, the battery cell according to the fourth embodiment has an advantage in that, when tension is applied to the electrode tab 300, the second break line 312 is broken, whereby the buffer portion is more rapidly relaxed.

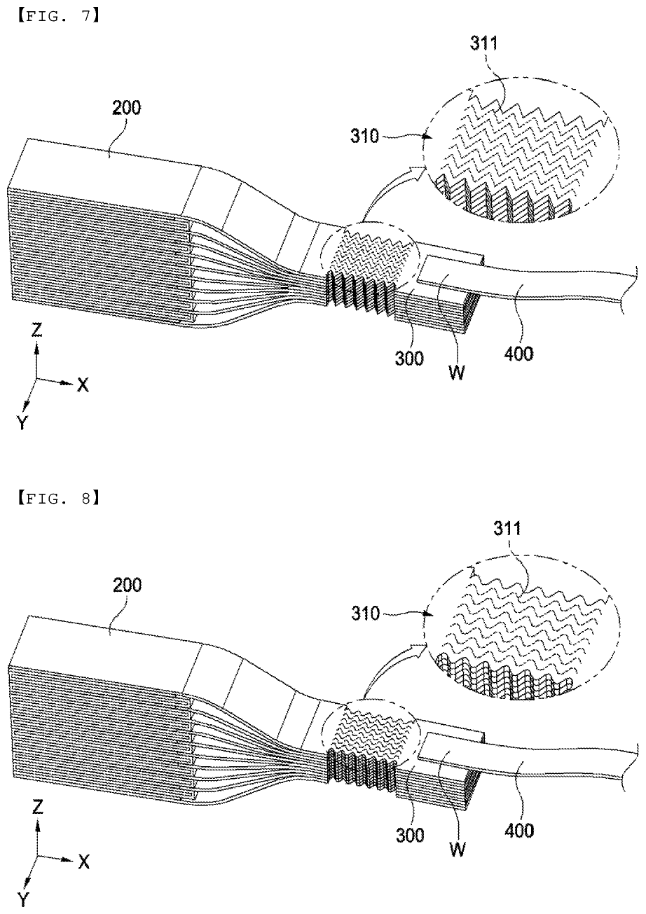

FIG. 7 is an enlarged perspective view of an electrode tab according to a fifth preferred embodiment of the present invention. Referring to FIG. 7, the battery cell according to the fifth preferred embodiment of the present invention is identical to the battery cell according to the first embodiment described with reference to FIGS. 2 and 3 except for the shape of a buffer portion 310, and therefore a description of the same construction will be omitted.

In the battery cell according to the fifth preferred embodiment of the present invention, the buffer portion 310 is configured such that a part of each of opposite edges of the buffer portion 310 in the lateral direction thereof (Y-axis direction) is incised in a zigzag shape and such that a plurality of first zigzag break lines 311 is formed in the longitudinal direction of the electrode tab 300 (X-axis direction).

FIG. 8 is an enlarged perspective view of an electrode tab according to a sixth preferred embodiment of the present invention. Referring to FIG. 8, the battery cell according to the sixth preferred embodiment of the present invention is identical to the battery cell according to the first embodiment described with reference to FIGS. 2 and 3 except for the shape of a buffer portion 310, and therefore a description of the same construction will be omitted.

In the battery cell according to the sixth preferred embodiment of the present invention, the buffer portion 310 is configured such that a part of each of opposite edges of the buffer portion 310 in the lateral direction thereof (Y-axis direction) is incised in a wavy shape and such that a plurality of first wavy break lines 311 is formed in the longitudinal direction of the electrode tab 300 (X-axis direction).

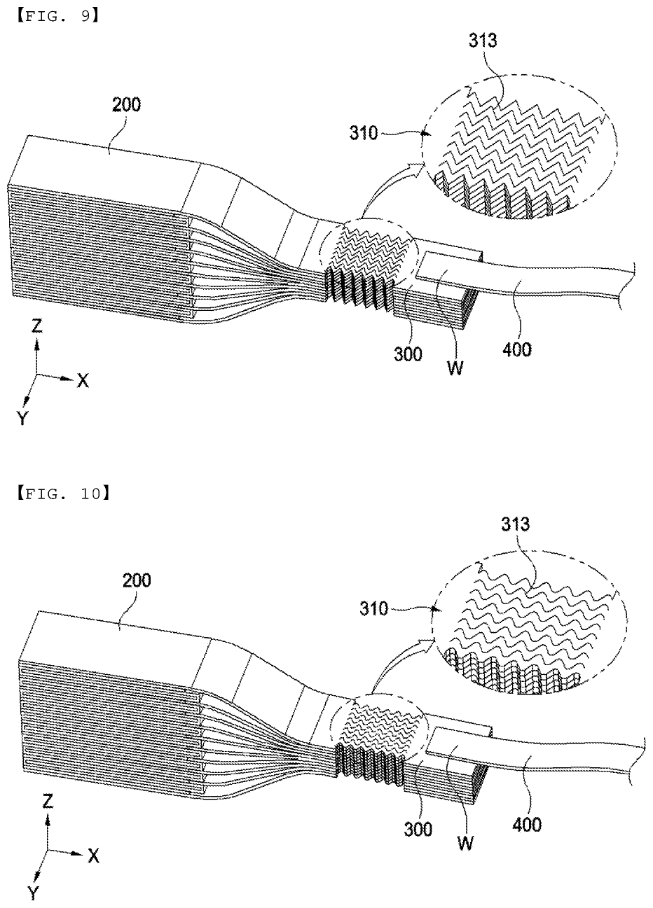

FIG. 9 is an enlarged perspective view of an electrode tab according to a seventh preferred embodiment of the present invention. Referring to FIG. 9, the battery cell according to the seventh preferred embodiment of the present invention is identical to the battery cell according to the first embodiment described with reference to FIGS. 2 and 3 except for the shape of a buffer portion 310, and therefore a description of the same construction will be omitted.

In the battery cell according to the seventh preferred embodiment of the present invention, the buffer portion 310 is configured such that a part of each of opposite edges of the buffer portion 310 in the lateral direction thereof (Y-axis direction) is incised in a zigzag shape and such that a plurality of zigzag incision lines 313 is formed in the longitudinal direction of the electrode tab 300 (X-axis direction).

As described above, the buffer portion 310 according to the seventh embodiment is constituted by only the plurality of incision lines 313. When tension is applied to the electrode tab 300, therefore, the electrode tab may be very rapidly stretched.

FIG. 10 is an enlarged perspective view of an electrode tab according to an eighth preferred embodiment of the present invention. Referring to FIG. 10, the battery cell according to the eighth preferred embodiment of the present invention is identical to battery cell according to the first embodiment described with reference to FIGS. 2 and 3 except for the shape of a buffer portion 310, and therefore a description of the same construction will be omitted.

In the battery cell according to the eighth preferred embodiment of the present invention, the buffer portion 310 is configured such that a part of each of opposite edges of the buffer portion 310 in the lateral direction thereof (Y-axis direction) is incised in a wavy shape and such that a plurality of wavy incision lines 313 is formed in the longitudinal direction of the electrode tab 300 (X-axis direction).

As described above, the buffer portion 310 according to the eighth embodiment is constituted by only the plurality of incision lines 313. When tension is applied to the electrode tab 300, therefore, the electrode tab may be very rapidly stretched.

In addition, the present invention may provide a battery module including the battery cell and a battery pack including the battery module.

Those skilled in the art to which the present invention pertains will appreciate that various applications and modifications are possible within the category of the present invention based on the above description.

### DESCRIPTION OF REFERENCE SYMBOLS

100: Case
110: Outer resin layer
120: Metal layer
130: Inner resin layer
200: Electrode assembly
300: Electrode tab
310: Buffer portion
311: First break line 312: Second break line
313: Incision line
400: Electrode lead
500: Insulative film
W: Connection portion

1. A battery cell comprising:
a case having a laminate sheet structure;
an electrode assembly received in the case;
an electrode tab extending from a side surface of the electrode assembly;
an electrode lead having a first side connected to the electrode tab and a second side projecting out of the case; and
insulative films disposed at each of an upper surface and a lower surface of the electrode lead,
wherein the electrode tab includes a buffer portion thereof, a length of the buffer portion being adjustable.

2. The battery cell according to claim 1, wherein the buffer portion is located between a connection portion of the electrode tab that is connected to the first side of the electrode lead and the electrode assembly.

3. The battery cell according to claim 2, wherein the buffer portion has a plurality of first zigzag break lines extending in a longitudinal direction of the electrode tab.

4. The battery cell according to claim 2, wherein the buffer portion has a plurality of first wavy break lines extending in a longitudinal direction of the electrode tab.

5. The battery cell according to claim 2, wherein the buffer portion has a plurality of zigzag incision lines extending in a longitudinal direction of the electrode tab.

6. The battery cell according to claim 2, wherein the buffer portion has a plurality of wavy incision lines extending in a longitudinal direction of the electrode tab.

7. The battery cell according to claim 3, wherein the buffer portion has two second break lines disposed at first and second opposite edges of the buffer portion, respectively, the two second break lines extending in a lateral direction of the electrode tab.

8. The battery cell according to claim 2, wherein the buffer portion is configured such that:
a part of each of first and second opposite edges of the buffer portion in a lateral direction of the electrode tab is incised in a zigzag shape; and
a plurality of first zigzag break lines extend in a longitudinal direction of the electrode tab.

9. The battery cell according to claim 2, wherein the buffer portion is configured such that:
a part of each of first and second opposite edges of the buffer portion in a lateral direction of the electrode tab is incised in a wavy shape; and
a plurality of first wavy break lines extend in a longitudinal direction of the electrode tab.

10. The battery cell according to claim 2, wherein the buffer portion is configured such that:
a part of each of first and second opposite edges of the buffer portion in a lateral direction of the electrode tab is incised in a zigzag shape; and
a plurality of zigzag incision lines extend in a longitudinal direction of the electrode tab.

11. The battery cell according to claim 2, wherein the buffer portion is configured such that:
a part of each of first and second opposite edges of the buffer portion in a lateral direction of the electrode tab is incised in a wavy shape; and
a plurality of wavy incision lines extend in a longitudinal direction of the electrode tab.

12. The battery cell according to claim 2, wherein the buffer portion does not overlap the insulative film in a vertical direction perpendicular to a plane of the electrode tab.

13. A battery module comprising the battery cell according to claim 1.

14. A battery pack comprising the battery module according to claim 13.

15. The battery cell according to claim 4, wherein the buffer portion has two second break lines disposed at first and second opposite edges of the buffer portion, respectively, the two second break lines extending in a lateral direction of the electrode tab.

16. The battery cell according to claim 5, wherein the buffer portion has two second break lines disposed at first and second opposite edges of the buffer portion, respectively, the two second break lines extending in a lateral direction of the electrode tab.

17. The battery cell according to claim 6, wherein the buffer portion has two second break lines disposed at first and second opposite edges of the buffer portion, respectively, the two second break lines extending in a lateral direction of the electrode tab.
